(19) United States
(12) Patent Application Publication
(10) Pub. No.: US 2025/0336006 A1
(43) Pub. Date: Oct. 30, 2025

(54) SYSTEMS AND METHODS TO AUTOMATICALLY COMPLETE A TAX FORM BY GENERATING A TRANSFORMED DATASET USING A MACHINE LEARNING MODEL IN AN ARTIFICIAL INTELLIGENCE INFRASTRUCTURE

(71) Applicant: Michelle Ann Diaz, New Orleans, LA (US)

(72) Inventor: Michelle Ann Diaz, New Orleans, LA (US)

(21) Appl. No.: 18/648,354

(22) Filed: Apr. 27, 2024

(51) Int. Cl. G06Q 40/12

(52) U.S. Cl. CPC G06Q 40/123

(57) ABSTRACT

Computer-implemented systems and methods to automatically complete a tax form by generating a transformed dataset using a machine learning model in an artificial intelligence infrastructure.

### FIELD

Some implementations are generally related to machine learning systems and, in particular, to systems and methods to automatically complete a tax form by generating a transformed dataset using a machine learning model in an artificial intelligence infrastructure.

### BACKGROUND

There are approximately 1.8 million tax-exempt organizations (TEOs) in the USA. These organizations, due to their public-interest missions, are granted exemption from income tax by the Internal Revenue Service. Approximately 1 million of them are required to annually file a Form 990, (“990”), a 12-page informational tax return. The filing of the 990 is an important requirement for these TEOs because failure to file it can result in automatic revocation of the coveted tax-exempt status of the TEO.

Preparing the 990 typically requires a TEO to extract information from sprawling data sources. A TEO's data repositories commonly consists of three systems: (1) one of about nine accounting systems, such as Quickbooks or Blackbaud (2) one of about ten CRM systems such as Salesforce or Raiser's Edge and (3) one of about five payroll software, such as Paychex. These platforms do not provide functionality for a TEO to prepare its Form 990.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Some implementations can include systems and methods to automatically complete a and file an electronic tax form by generating a transformed dataset for use by a machine learning model in an artificial intelligence infrastructure.

Because TEOs are typically heavily invested (e.g., financially and/or trained) in their existing software, an implementation of the disclosed system addresses a technical problem of current systems by bridging the current data silo between the TEO's data estate and the 990 electronic tax form. Some implementations can include hyper-automation, which includes a bespoke fusion of computer techniques including algorithms, artificial intelligence, intelligent data capture, and data processing techniques singularly focused and uniquely and specifically trained in 990 expertise to programmatically transform a TEO's raw data from its repositories into “990 Data.” The 990 Data is then automatedly mapped and displayed onto an e-filable 990 tax return.

Thus, some implementations solve interoperability and data silo technical problems to provide immense value to potentially hundreds of thousands of TEOs annually.

### BRIEF DESCRIPTION OF THE DRAWINGS

FIG. 1 is a block diagram of an example system and a network environment which may be used for one or more implementations described herein.

FIG. 2 is a high-level block diagram of a TEO tax form system in accordance with some implementations.

FIG. 3 is a flowchart of an example method using artificial intelligence to transform raw data into TEO tax form data in accordance with some implementations.

FIG. 4 is a flowchart of an example data collection method in accordance with some implementations.

FIG. 5 is a flowchart of an example data preparation method in accordance with some implementations.

FIG. 6 is a flowchart of an example data processing method in accordance with some implementations.

FIG. 7 is a flowchart of an example automated Form 990 accounting method in accordance with some implementations.

FIG. 8 is a flowchart of an example data integration and mapping process in accordance with some implementations.

FIG. 9 is a block diagram of an example computing device which may be used for one or more implementations described herein.

### DETAILED DESCRIPTION

Some implementations include systems and methods to automatically complete a tax form by generating a transformed dataset using a machine learning model in an artificial intelligence infrastructure.

Approximately 1 million TEOs, commonly referred to as “non-profits”, are required to file a Form 990 Return of Organization Exempt From Income Tax (“Form 990”) annually with the Internal Revenue Service (IRS) so the TEO can maintain its highly coveted tax-exempt status. (e.g., See Appendix E). Three years of non-filing of the Form 990 triggers auto-revocation of a TEO's highly-coveted tax exempt status by the IRS. Additionally, the Form 990 is open to public inspection on the IRS' website. Thus, a properly, timely, and accurately prepared Form 990 is indispensable and essential to the repute of any TEO.

When a TEO seeks funding, its annual Form 990 is almost always requested as it communicates the TEO's mission, programs and financial outcomes, effectively making the 990 the “bloodline” for many TEOs. The IRS recently mandated electronic filing of the 990 that embeds many cross-references and sub/totals which prevents “over-rides” that were possible when was prepared manually.

E-filing mandates TEOs to now enter their 990 into yet another system as there is a finite list despite the fact that the 990 is a TEO's singular most important, existential regulatory requirement and is typically of paramount importance to its funding, a current huge data silo creates immense challenges in preparing the 990. The data silo is due to the extensive extraction of data from disparate systems, parsing, reconciling, and manual data entry required to prepare the 990. Because the 990 is highly specialized as it requires niche information that is unique to the nonprofit sector, preparing it commonly poses a significant administrative burden to many TEOs

Existing TEO data repositories (e.g., accounting such as Quickbooks and NetSuite, CRM such as Salesforce and Raiser's Edge and payroll such as ADP or Paychex) do not provide any integration with the electronic Form 990 whatsoever. Furthermore, the data output from those data repositories typically does not even “align” with the Form 990 which has highly specialized and unique reporting requirements. This absence of synthesis results in TEOs or their tax preparers having to wrestle with fragmented data and conduct extensive parsing and reconciling just to obtain the data required for the 990. This laborious process of having to “fit a square peg in a round hole” typically takes days if not weeks of time for many TEOs.

Lastly, once all the data is finally centralized, it must then be all manually entered onto a separate platform of an IRS authorized 990 e-filer.

A solution which resolves these specific and unique data challenges with a novel and targeted approach may be desired.

The disclosed subject matter includes a software system (“e990”), which pioneers a distinct method tailored to bridge the current technological gap between a TEO's data estate and 990 tax software (see, e.g., Appendix F). An implementation of the e990 system can improve the functionality of a computer by having it distinctly trained, through hyper-automation (described below), to transform heterogenous data into 990 Data to generate an electronic Form 990 suitable for filing with the IRS. As a first of its kind, the e990 system can include deeply customized system deploys a novel use of Hyperautomation technologies that enables TEOs or their tax preparers to now prepare and e-file their Form 990 tax return with information extracted and transformed directly from their data repositories. This eliminates the immense parsing, assembling, and manual data entry that may be required for conventional Form 990 processes.

The combination of e990 features and functionalities enables a TEO or its tax professional to prepare its Form 990 in a profoundly more efficient manner. In fact, once the required data sets are uploaded, a process that would have taken a person hours, or even days, to gather, prepare, reconcile, and enter may now be transformed into 990 Data to generate its Form 990 return within minutes if not seconds. Thus, an implementation of e990 can extend an invaluable and remarkable improvement over current conventional practices.

Some implementations of e990 encompass three primary technologies as described below working as ensemble yet singularly focused on improving the functionality of a computer by equipping it with Form 990-specific expertise and preparation capabilities.

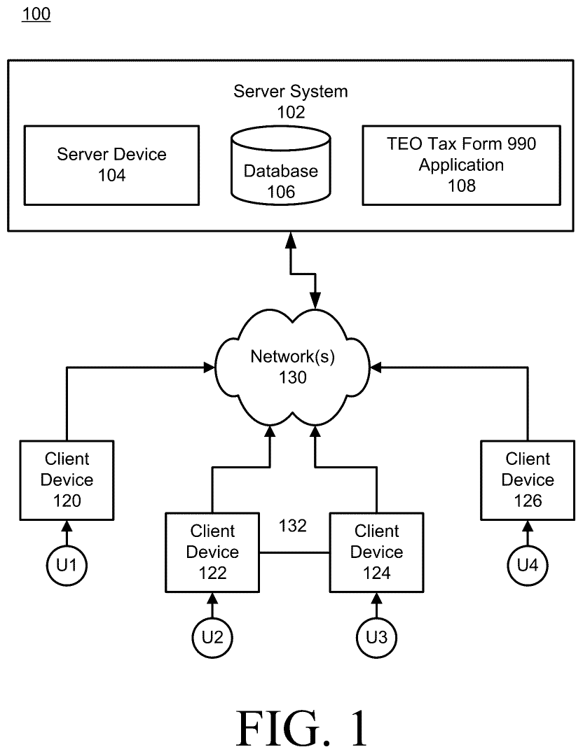

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and TEO Tax Form 990 (or e990) application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide TEO tax form functions as described herein.

Various implementations of features described herein can use any type of system and/or service. Any type of electronic device can make use of the features described herein. Some implementations can provide one or more features described herein on client or server devices disconnected from or intermittently connected to computer networks.

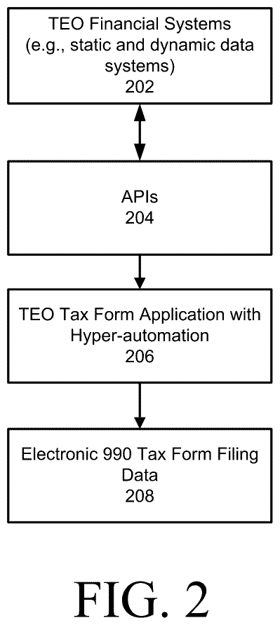

FIG. 2 is a high-level block diagram of a TEO tax form system in accordance with some implementations. The data from TEO data sources 202 can be imported via one or more Application Programming Interfaces (“APIs”) 204.

Some implementations can include one or more APIs whose purpose is to connect the TEO tax form system to data repositories prevalent amongst TEOs. See Appendix F. This connection involves an ability to access an often-sprawling system of distributed data of as many as ten different accounting platforms, another ten CRM platforms, and five payroll platforms.

Because each has its own permission/security requirements and varying loan and scalability needs, the APIs of an implementation are necessarily developed with various programming languages and technologies, customized to each platform to which it is connecting.

The coding for each API implements the necessary logic, methods, endpoints and expected requests and responses to effectuate the successful access (which may or may not be “migrated in” to maximize resource efficiency) of 990-pertinent data from the data repositories.

In some implementations, the API framework includes the following library of components, the selection of which is entirely dependent on the specific data repository to which it is connecting.

### API Protocols

The API protocols, the set of rules and standards that govern how an implementation's data is received and transmitted over its network, is entirely based on the requirements of the specific data repositories to which a given implementation is connecting. The protocols include:

HTTP/HTTPS (Hypertext Transfer Protocol/Secure): widely used for web APIs, especially RESTful services.

SOAP (Simple Object Access Protocol): A protocol for exchanging structured information in the implementation of web services, often using XML for message format.

REST (Representational State Transfer): Not a protocol per se, but an architectural style mostly used over HTTP/HTTPS, popular due to its simplicity.

gRPC: Developed by Google, it's a high-performance, language-agnostic RPC (Remote Procedure Call) framework.

JSON-RPC and XML-RPC: Both are remote procedure call (RPC) protocols encoded in JSON and XML data formats respectively.

WebSocket: Allows for full-duplex communication channels over a single TCP connection, suitable for real-time applications.

MQTT (Message Queuing Telemetry Transport): A lightweight messaging protocol for small sensors and mobile devices, optimized for high-latency or unreliable networks.

CoAP (Constrained Application Protocol): A web transfer protocol for use with constrained nodes and constrained networks, often used in IoT devices.

Graph L: A query language for your API, and a server-side runtime for executing queries by using a type system you define for your data.

AMQP (Advanced Message Queuing Protocol): A messaging protocol that supports messaging patterns like point-to-point request-reply and publish-subscribe.

STOMP (Simple (or Streaming) Text Oriented Message Protocol): A simple text-based protocol for working with message-oriented middleware.

### API Programming Languages

avaScript: with Express.js or Fastify frameworks in a Node.js environment.

Python: with Flask, Django, and FastAPI frameworks.

ava: with Spring Boot framework

C: with ASP.NET Core framework in the .NET environment

Ruby: Ruby on Rails may also be used to create e990's APIs.

Go (Golang): Using its libraries like Gorilla Mux that facilitate API development.

Rust: with Rocket framework

PHP: with Laravel or Laminas framework

### API Authentication and Authorization

OAuth 2.0: A standard protocol for authorization.

JWT (JSON Web Tokens): Compact URL-safe means of representing claims to be transferred between two parties.

API Keys: Simple authentication using unique keys.

Basic Authentication: Uses base64-encoded username and password for authentication.

### API Database Technology

Relational Databases: PostgreSQL, MySQL, Microsoft SQL Server, SQLite.

NoSQL Databases: MongoDB, Cassandra, CouchDB.

In-memory Databases: Redis, Memcached.

### API Documentation and Testing Tools

Swagger/OpenAPI: A framework for API specification that includes a suite of tools for autogenerating

documentation, client SDK generation, and API testing.

Postman: A prominent tool for API testing.

Orchestration: Kubernetes helps manage and scale containerized applications.

Insomnia: Another tool for API testing and exploration

Containers: Docker allows the system to package an API as a container, making it easy to deploy/scale.

Cloud Providers: Such as AWS, Google Cloud Platform, and Azure, for hosting and management.

The imported data from the APIs 204 is processed by the TEO Tax Form Application with hyper-automation 206. In particular, the core of the disclosed method and system's unique value offering of enabling TEOs to generate an electronic Form 990 directly from its data sources is its data ecosystem.

Hyper-automation, in turn, is key to how an implementation can administer the data.

As used herein, hyper-automation, is a highly tailored fusion of Artificial Intelligence, Automations, Intelligent Algorithms, Intelligent Data Capture and Data Techniques, and is a fundamental technology in the disclosed software system. Hyper-automation is described in greater detail below.

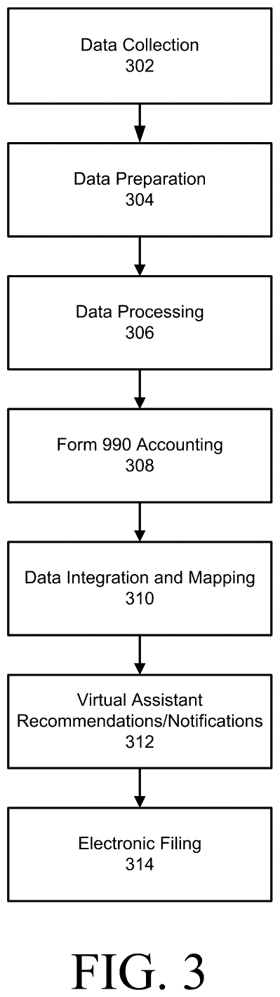

In some implementations, the data ecosystem includes data definitions and indexes, data domains, and data tasks (e.g., see FIG. 3).
e990 Data: Definition and Index
e990 Data Domains
   e990 Data Tasks:
Task 1: Data Collection
Task 2: Data Preparation
Task 3: Data Processing
(i) For all Static Data
(ii) For Dynamic Data: e990 Schedules
(iii) For Dynamic Data: All remaining
Task 4: Integration and Mapping
e990's Hyper-automation: The toolbox that powers e990's Data Tasks
   Feature 1>e990AI: e990's Artificial Intelligence
   Feature 2>e990RPA: e990's Robotic Process Automation

The TEO Tax Form Application with Hyper-automation 206 transforms the input data received via APIs into data for the Form 990 data 208.

### DATA: Definition and Index

The system data includes the precise data required by the reporting requirements of the IRS' prescribed 990 tax form and whose properties and attributes conforms with these TEO Tax Form Application Data Standards:
1. Accuracy: The data correctly provides the information required by Form 990.
2. Format/Type: The structure or presentation of the data such as alpha versus numeric is correct for Form 990
3. Source: The data's origin is appropriate for Form 990. For example, government grants revenue would typically come from a TEO's accounting system; not its payroll system
4. Granularity: The level of detail the data provides is suitable for the 990 field. For example, provides individual data vs. aggregated data where Form 990 requires.
5. Veracity: The Form 990 data is of quality, trustworthiness, accuracy and is reliable.
6. Completeness: There are no missing values or incomplete records underlying the 990 data
7. Relevance: The data has the right context for the particular Form 990 field
8. Timeliness: The data pertains to the relevant year of the 990

Form 990 data encompasses answers, required reporting schedules and other data sets that are so unique that the 990 is oftentimes the only instance that its required information is needed.

Some implementations are uniquely able to transform data from a TEO repository into “Form 990 Data”.

Some implementations can include a Data Index as follows:

### I Prior Year Data: All Columns Titled:

Prior Year,
Beginning of Current Year, or
Beginning of Year

### II Current Year Data:

### A. Non-Monetary Data

1. TEO Profile (990 Header #A-K)
2. Activities and Governance (990 Part I)
3. Signature Block (990 Part III)
4. Checklist of Required Schedules (990 Part IV)
5. Statements re: Other Filings and Tax Compliance (990 Part V)
6. Governance, Management and Disclosure (990 Part VI)
7. Financial Statement and Reporting (990 Part XII)

### B. Monetary Data

1. Program Service Accomplishments (990 Part III)
2. Compensation: Officers, Directors, Trustees, Key/HC Employees (VII-A)
3. Compensation of Independent Contractors (990 Part VII-B)
4. Financial Statements (990 Parts VIII-XI)

### Data Domains

Some implementations can distinctly establish the following DATA DOMAINS:

### A. Static Data

(i) Profile Information (PI): 990 fields pertaining to the TEO's profile that are unlikely to change such as name, address, EIN, website, year formed, mission.
(ii) Prior Year Data (PY): Any 990 fields for columns headed “Prior Year” or “Beginning of Year” or “Beginning of Current Year”
(iii) Non-Conditional Data (NC): Fields that are not dependent on another field of condition, e.g.: Accounting method used to prepare the Form 990 (select): Cash Accrual Other

Is the organization a school described in section 170(b)(1)(A)(ii)? If “Yes,” complete Schedule E

Is the organization a section 501(c)(4), 501(c)(5), or 501(c)(6) organization that receives membership dues, assessments, or similar amounts per Rev. Proc. 98-19? If Yes, complete Schedule C, Part III

Did the organization maintain collections of works of art, historical treasures, or other similar assets? If “Yes,” complete Schedule D, Part III

Note: In the last three examples above, an implementation is configured to generate a report of any required supplemental schedules.

### B. Dynamic Data

(i) Current Year “e990 Schedules” (SC):
(a) Program Services (990 Part III #4a-4e)
(b) Officers, Directors, Trustees, Key Employees and HCEs (990 Part VII-A)
(c) Independent Contractors (990 Part VII-B)
(d) Financial Statements (990 Parts VIII, IX, X and XI then to Part 1 #8-22)
(ii) Conditional Data (CL): All fields that are dependent on another field or condition.

### E990 Identifies 3 Classes of Conditional Data:

1. All cross-references and math results are by their nature “conditional data”.

### Illustrative Examples of Cross-Reference Fields

Part I Summary: Revenue #8-11, Expenses #13-17, and Net Assets #20-21

### Illustrative Examples of Math Result Fields

Part I Summary: Revenue #12, Expenses #18 and 19, and Net Assets #22

2. Any field whose answer depends on the result of another field is “conditional data”.

### Illustrative Examples

Did the organization report an amount in Part X line 21? If YES, complete Schedule D

Did the organization report more than $15,000 of gross income from gaming activities on Part VIII, line 9a? If “Yes,” complete Schedule G, Part III

Did the organization report an amount for investments—other securities in Part X, line 12, that is 5% or more of its total assets reported in Part X, line 16? If “Yes,” complete Schedule D, Part VII.

Note: In the last three examples above, the system generates a report of any required supplemental schedules.

3. Any field where a “follow-up” response from the TEO is required. Examples:

After the system determines the 3 largest Programs by expenses, per part III #4, the TEO must provide the revenue, grants, and a description for each of those specific Programs.

After e990 identifies any Independent Contractors who were compensated>$100,000, per Part VII-B, the TEO must provide its address and description of services.

4. Any field that is applicable to only certain types of TEOs.

For example: 990 Part V: #8-13 and #17

The attached Form 990 (Appendix I) labels the above Data Domains.

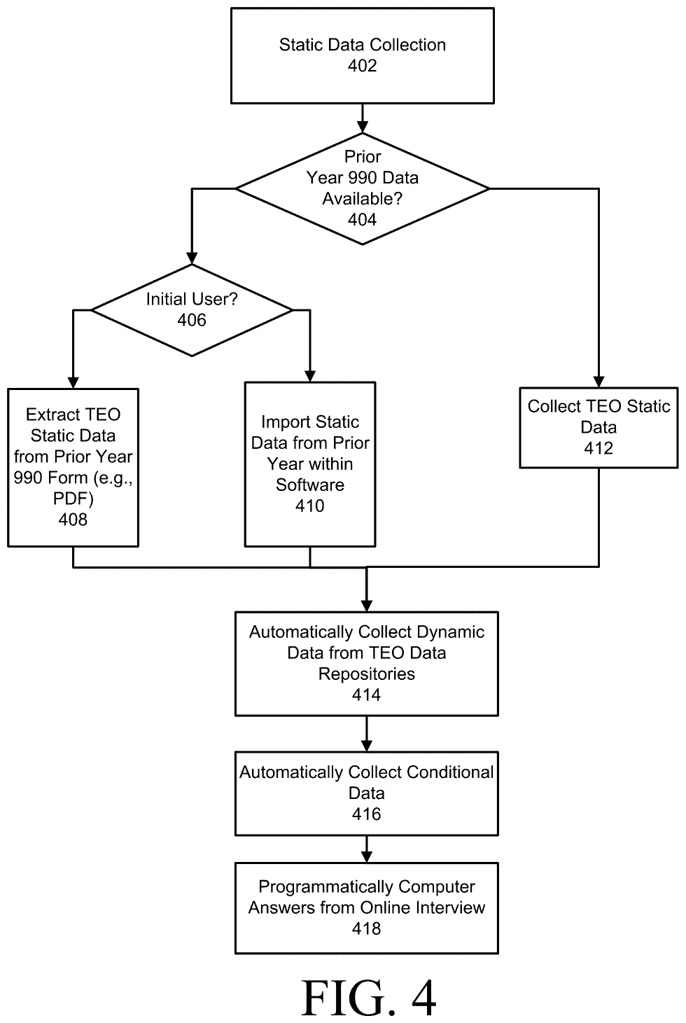

FIG. 3 is a flowchart of an example method using artificial intelligence to transform raw data into TEO tax form data in accordance with some implementations. Processing begins at 302, where data is collected from the TEO data environment. Data collection is described in greater detail below in connection with FIG. 4. Processing continues to 304.

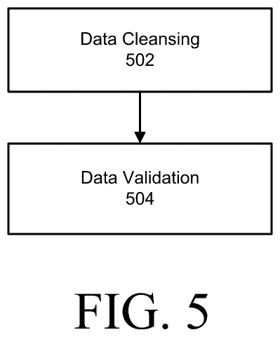

At 304, the collected data is prepared. Data preparation is described in greater detail below in connection with FIG. 5. Processing continues to 306.

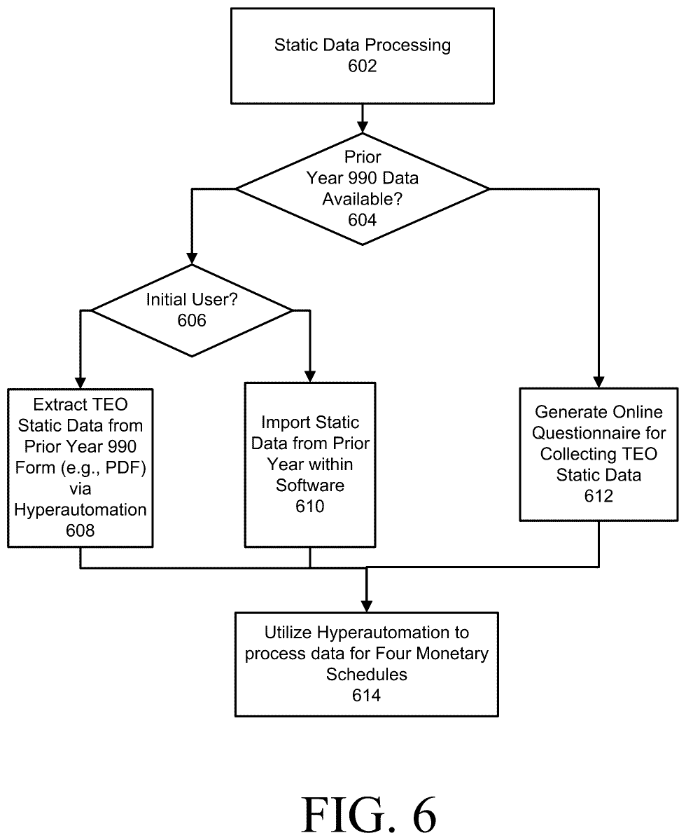

At 306, the data is processed. Details of the data processing are described below in connection with FIG. 6. Processing continues to 308.

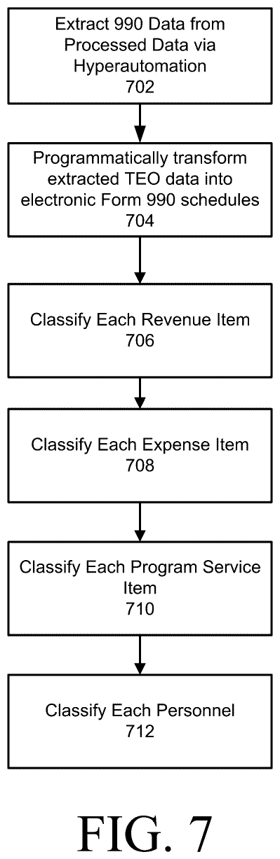

At 308, accounting for Form 990 is performed on the processed data. The Form 990 accounting is described in detail below in connection with FIG. 7. Processing continues to 310.

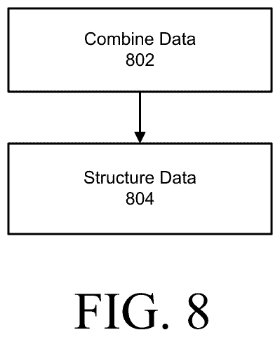

At 310, the accounting data is integrated and mapped. The details of the integration and mapping are described below in connection with FIG. 8.

At 312, virtual assistant recommendations and/or notifications are provided. For example, as a defining feature, some implementations of e990 can include embedded 990 expertise wherein a virtual assistant/chatbot displays IRS definitions, rules, warnings or helpful tips in the applicable fields as the TEO navigates through e990. e990 incorporates and provides specialized explanations and guidance from the official IRS 990 instructions. The Virtual Assistant is particularly helpful for those certain fields that call for 990 expertise or are a source of common errors.

Illustrative examples of Virtual Assistant messages:
Tip: Membership dues are not the same as Membership contributions
Tip: Unearned Grants is a “Deferred Revenue” account
Warning: Your state requires co-filing a return with them
Warning: Only the “contribution” portion of a fundraising event is reported on line 1 c; remainder on 8A
Tip: Direct expenses for a fundraiser are entered in the Other Revenue section 8b
Definition: The IRS defines Substantial Contributor (line X5) or Disqualified Persons (line X6) as . . . .
Warning: Compensation on the Functional Expenses schedule is not necessarily what's shown on the W2 as certain compensation, particularly when non-taxable, may not be included in the employee's W2 amount but should be included in the Functional Expenses schedule.
Info Needed: Since these Independent Contractors were compensated over $100 k, please enter their address and description of services
Warning: Total program service expenses at Part III 4e should equal Part IX 25(8) (although the 990 does not stipulate that).

### General Notes

The illustrative examples provided herein are not intended to be exhaustive or limiting and are in fact typically only a microcosm of the limitless ways in which e990 extends its functionalities and features.
Some aspects of e990 are singularly focused and specifically designed to provide the precise data needed for Form 990
e990 also automates required supporting schedules (e.g. Schedule B to populate Contributors) e990 also automates STATE returns where required
e990 utilizes technologies which automatically capture, recognize, and extract information from various types of documents, whether structured or not, and other ancillary sources This can include accounting reports, invoices, forms, emails, and other documents.
e990 is designed to facilitate “manual-free” data entry. However, a TEO may “over-ride” any “inputs” (but not totals or cross-reference validations if deemed necessary).
e990 can provide ad hoc accounting services needed to properly prepare 990. (Example: loan payments all posted to interest/none to principal, etc.). Processing continues to step 314.

At step 314, the automatically generated electronic Form 990 is filed. In some implementations, the e990 software is native (i.e., no data transfers needed and provides functionalities customary to commercial tax software, including/not limited to:

E-Filing: Permits TEOs to electronically file their Form 990 as recently mandated by the Internal Revenue Service. Provides confirmation of receipt from IRS. See E-Filing below for details.

Tax Return Prep Assistance: Guides TEOs through the process of preparing their Form 990 by asking relevant questions. See Virtual Assistant above for more details.

Accuracy Checks: Includes built-in error checks (such as validating cross-references) and calculations (such as totals/sub-totals) to minimize the risk of mistakes and to ensure accuracy.

Customer Support: e990 offers customer support through phone, chat, or email to assist TEOs with questions or issues.

Audit Support: e990 offers audit support through phone, chat, or email, providing guidance on how to respond to inquiries from the IRS.

State Tax Filing: Provides features for filing correlating state tax returns for those states that so require. TEOs can prepare/file both federal and state returns together.

Importing Previous Returns: Allows returning e990 users to import data from previous years' 990s to save time on data entry and maintain a history of tax filings.

Mobile Access: e990 provides mobile apps or web-based platforms, allowing users to work on their tax returns from smartphones or tablets.

Security Features: e990 employs encryption and other leading security measures to protect sensitive personal and financial information.

Print and Save Options: Allows TEOs to print copies of their 990, save digital copies for their records, or export data for future use.

### Form 990 E-Filing

The Internal Revenue Service (“IRS”) recently mandated that the 990 be electronically filed (i.e., no mailing or hand delivery). The IRS accepts e-filings from only authorized transmitters. To gain such authorization, one must undergo rigorous assurance testing.

Below is the IRS' official current list of those authorized E-filers.

Each fall into one of these two categories:
a) Those who permit direct filings by TEOs but house no TEO source data:
   Advanced Tax Solutions, LLC
   TaxSlayer Pro
   Profit Developers Inc-DBA SAXT AX
   Simple Filings LLC
   On-Line Taxes, Inc.
   Block Works
   Tax Technologies, Inc.
   Tax990
   Form 990 Online
   CrossLink Professional Tax Solutions, LLC
   RENOSI, Inc.
   K1x, Inc.
   Taxware Systems
or

b) Those who offer e-filings only as part of their tax-preparer-geared-software
Drake Software
Intuit (but not for its Quickbooks)
Lacerte Software
Thomson Reuters CS Professional Suite
TaxAct, Inc.—Business Returns
CCH Small Firm Services-ATX
GOSYSTEM-Thomson Reuters
ProConnect Tax Online
Thomson Reuters ONESOURCE Trust Tax
CCH a Wolters Kluwer business

e990 is currently enrolling as an IRS-authorized e-filer and will thus, importantly, be the one and only platform that the present inventor is aware of which resolves this data silo by enabling a TEO or his tax preparer to connect its data estate directly to a 990-tax software.

FIG. 4 is a flowchart of an example data collection method in accordance with some implementations. Processing begins at 402 with static data collection. Processing continues to 404, where it is determined whether prior year 990 data is available. If so, processing continues to 406. Otherwise, processing continues to 412.

At 406, it is determined whether the user is an initial user. If not, processing continues to 408. Otherwise, if the user is a returning user, processing continues to 410.

At 408, the system via API, e990's Hyperautomation, integrally the Advanced Intelligent Data Capture (AIDC) technology, extracts all TEO Static Data from the TEO's prior year 990 pdfs (via direct upload or feed from IRS database). Processing continues to 414.

At 410, the system imports prior year e990 data directly within e990 software. In some implementations, the TEO may elect to over-ride any AIDC or Import results. Processing continues to 414.

At 412, when prior year 990 data is not available, e990's deploys web-based survey and form-building platforms and technologies to provide the TEO with an online questionnaire to collect the TEO's Static Data. Processing continues to 414.

At 414, via API, e990's Hyperautomation, integrally its Artificial Intelligence, Intelligent Algorithms, and Data Techniques technologies, deploys custom algorithms to collect the dynamic data for the e990 Schedules directly from the TEO's data repositories. Processing continues to 416.

At 416, conditional data is automatically collected. Via API, e990's Hyperautomation, integrally its robotic process automation (RPA), collects the Conditional Data. Processing continues to 418.

At 418, via API, e990's Hyperautomation, integrally its robotic process automation (RPA), collects the Conditional Data thru (1) algorithms coded to compute these answers and (2) from online interview with TEO. In some implementations, algorithms: specifications are dictated by the processing as described in Task 3: Data processing described in connection with FIG. 6 below.

FIG. 5 is a flowchart of an example data preparation method in accordance with some implementations. The data collected from TEO sources may need to be cleansed (502) and/or validated (504) to ensure the accuracy needed for the Form 990. Effective cleansing and validation are critical to data preparation. The e990 system uses leading data cleansing and data validation tools (and oftentimes a combination of these tools) such as these to resolve data quality needs that are specific to the 990:
>Trifacta>Informatica DQ>Talend DQ>SAS Data Mgmt
>OpenRefine>DataRobot>Melissa DQ>Experian DQ
>WinPure>IBM Infosphere>Data Ladder>Microsoft SQL DS

e990's data preparation tools may also deploy Natural Language Processing (NLP) in Large Language Models (LLM). e990 can utilize turn-key NLP (e.g., conversational data preparation) tools when possible, or custom-made, when necessary, for its data cleansing and validation.

Below are illustrative and non-limiting e990 data cleansing tasks:

1. Converting 990-specific Data: Corrects 990-specific data, such as converting a TEO's EIN from 123-456-789 to the IRS preferred format of 12-3456789.

2. Lemmatization: Reducing a word to its root form (“lemma”). For example, the verb “running” would be identified as “run.”

3. Removing Duplicates: Identifying and removing duplicate records or entries in a dataset. Duplicate data can skew analysis and reporting.

4. Handling Missing Values: Resolving missing/null values by filling them in with appropriate values, removing rows with missing data, or imputing missing values using statistical techniques.

5. Standardizing Data: Ensuring consistency by standardizing data formats, such as dates, addresses, or phone numbers, to a common format. For example, converting “2023 Jan. 5” to “Jan. 5, 2023.”

6. Correcting Typos and Misspellings: Identifying and correcting typographical errors and misspellings in textual data; particularly important for text-based analysis and search.

7. Dealing with Inconsistent Capitalization: Standardizing the capitalization of text data to ensure uniformity. For example, converting “revenue” to “Revenue.”

8. Removing Unnecessary Characters: Eliminate unnecessary words (such as “a”, “an”, “the”), special characters, symbols, or non-alphanumeric characters that disrupt analysis or cause errors.

9. Handling Outliers: Identifying and addressing outliers or extreme values in numerical data. Depending on the context, outliers can be corrected, removed, or retained.

10. Converting Data Types: Ensuring that data types are appropriate for their intended use. For example, converting text-based numerical values to numeric data types.

11. Addressing Inconsistent Units: Standardizing measurement units for uniformity. For instance, converting measurements from days to hours for the 990 compensation schedules.

12. Removing Irrelevant Data: Identifying and removing data that is irrelevant or outdated.

13. Consolidating Categories: Combining or reclassifying similar categories or labels in categorical data to reduce complexity and improve analysis.

14. Handling Date and Time Discrepancies: Resolving issues with date and time data, such as inconsistent date formats.

Below are non-limiting illustrative examples of e990 data validation tasks:

1. Consistency Checks: Comparing data in one field with data in another field to ensure consistency. For example, verifying that the # of employees listed in Section VII does not exceed the # in Part V 2a box.

2. Reference Validation: Confirming that data references are accurate. For example, Part III #4e should equal Part IX #25 column B.

3. Conditional Validation: Applying validation rules based on certain conditions. For example, validating 990 field H (b) only if the answer to H (a) was YES.

4. Custom Validation Logic: Implementing custom validation logic unique. For example, if the TEO changes its address, the “Address Change” box is auto checked.

5. Date Validation: Verifying that dates and times are in the correct format and within reasonable ranges. This may include checking for valid calendar dates that fall within the 990-reporting year or that the End date is not before the Begin date.

6. Unique Key Validation: Ensuring that a specific attribute or combination of attributes is unique within a dataset. For example, validating that no donor name is duplicated.

7. Length Validation: Checking the length of text strings, like employee's names, to ensure they do not exceed a specified Form 990 maximum length.

8. Data Type Validation: Verifying that data is of the correct data type. For instance, ensuring that monetary data is represented as numeric values and not as text.

9. Numeric Range Validation: Ensuring that numeric values fall within a specified range. For example, validating that financial statement values are not negative.

10. Format and Pattern Validation: Validating that data adheres to specific formats or patterns. For instance, validating that the “$” sign is removed from financial data

11. Mandatory Field Validation: Ensuring that required fields are not left blank or null. Users may be prompted to provide data for mandatory fields.

12. List or Enumerated Value Validation: Validating that data matches a predefined list of acceptable values. For instance, checking that a state code is one of the valid state abbreviations.

13. Pattern Matching and Regular Expressions: Using regular expressions to validate that data conforms to specific patterns, such as validating a postal code format.

14. Cross-Field Validation: Checking data consistency across multiple fields. For example, ensuring that the start date is earlier than the end date and that the end date is not in the past.

15. Data Range Validation: Verifying that data falls within a predefined range. This is often used for numeric or date data, ensuring that values are not too high or too low.

FIG. 6 is a flowchart of an example data processing method in accordance with some implementations. To achieve maximum efficiency and optimization, e990's software conducts Maximum Parallel Processing (MPP) which identifies and enables every possible instance to execute tasks contemporaneously. The following is a description of e990's Data Processing methodology. Processing begins at 602 where static data is processed. Processing continues to 604, where it is determined whether prior year 990 data is available. If so, processing continues to 606. Otherwise, processing continues to 612.

At 606, it is determined whether the user is an initial user. If not, processing continues to 408. Otherwise, if the user is a returning user, processing continues to 610.

At 608, the system via API, e990's Hyperautomation, integrally the Advanced Intelligent Data Capture (AIDC) technology, processes TEO Static Data from the TEO's prior year 990 pdfs (via direct upload or feed from IRS database). Processing continues to 614.

At 610, the system imports prior year e990 data directly within e990 software. In some implementations, the TEO may elect to over-ride any AIDC or Import results. Processing continues to 614.

At 612, when prior year 990 data is not available, e990's deploys web-based survey and form-building platforms and technologies to provide the TEO with an online questionnaire to collect the TEO's Static Data. Processing continues to 614.

At 614, via API, e990's Hyperautomation, integrally its Artificial Intelligence, Intelligent Algorithms, and Data Techniques technologies, deploys custom algorithms to process the dynamic data for the e990 Schedules directly from the TEO's data repositories.

e990's “990 Accounting” powered by its Hyperautomation, integrally its Artificial Intelligence, Intelligent Algorithms, and Data Techniques technologies, deploys custom algorithms to perform these tasks for the 4 sets of monetary schedules, “e990 Schedule(s)”:

### (i) Program Services (Part III #4a Through 4e)

1. e990, via API, imports a dataset, typically sourced from the TEOs accounting system, which lists the name of each Program with its respective total expenses for the year.

2. e990 is coded to then calculate/determine which Programs have the 3 largest expenses.

3. e990 then, using Hyperautomation, principally RPA, prompts the TEO to upload a separate dataset which provides the correlating Revenue and Grant amounts for those specific “3 largest expenses” Programs

4. Alternatively, the TEO's dataset in step 1 also includes the Revenue and Grants data for each Program, allowing e990 to skip step 3 and simultaneously report the Revenue and Grants for those “3 largest expenses” Programs.

### (ii) Officers, Directors, Trustees, Key/Highly Compensated Employees (Part VII-a)

1. e990, via API, imports a dataset, typically sourced from the TEO's human resources system, which lists the name, title and position as per Column C for each (and all) Officer, Director, Trustee, Key Employee and Highly Compensated Employee.

2. e990, via API, imports a dataset, typically sourced from the TEO's payroll system, which lists the “reportable compensation” (RC) amount for each of the above individuals. The RC may be imported on a structured format such as a spreadsheet or from an image of the individual's W2 or 1099. In either format, e990 extracts, typically using AIDC, each name and correlating RC.

3. Step 2 is repeated for “other compensation” (OC) except OR not on W2/1099

4. The precise reporting criterion as listed on VII A is coded into e990's software.

5. e990, using Hyperautomation, compares #s 1 and 2 and #1 and 3 to determine any results that meet the criterion listed in #4

(iii) Independent Contractors (Part VIII-B)

1. e990, via API, imports a dataset, typically sourced from the TEO's accounting system, which lists the name and compensation of each Independent Contractor (or IC).

2. e990, using its Hyperautomation, identifies those ICs who received over $100 k compensation.

3. e990 using RPA then auto-prompts the TEO to enter the address and description of services for each so-identified IC

### (iv) Financial Statements (Parts VIII-XI)

1. Via its API, e990 extracts the TEO's trial balance from the TEO's accounting system to load it into e990.

2. e990 then deploys its Hyperautomation to:

a. compare the TEO's accounts as named in its trial balance to e990's chart of accounts to identify the TEOs accounts which, after data preparation, match e990's CoA. A “match” example is where a TEO's CoA already correctly segregates its payors by type (federated campaigns vs membership dues, etc.) per e990's CoA.

b. e990 tools such as the optional worksheet at Appendix D which have been input into e990 further facilitate “matching” the TEOs CoA to e990's CoA.

c. Any “matches” are placed in an “on-hold” mode

3. For account names that do not “match” e990's CoA:

a. e990 then segregates and routes those TEO's accounts through its “990 Accounting”

Hyperautomation for its transformation to the e990 CoA. See Exhibit for illustrative “instant” transformation examples.

b. In cases where e990 is not able to generate an “instant” transformation, it deploys its Hyperautomation, fundamentally AI, to auto-prompt the TEO for additional info which e990 determines may assist in completing the transformation. For example, in 2(a) above, e990 will prompt the TEO to upload a dataset that lists each payment received by payor name so that e990 may calculate the appropriate “payor by type” allocations.

4. In those outlier instances where e990 is unable to match a TEO's account to the e990 CoA, e990 incorporates “Human-in-the-loop” RPA prompts to complete that conversion.

5. Human-in-the-loop is also inserted where e990's conversions are especially complex or have a conversion accuracy success rate lower than a certain threshold. e990 allows the user to “over-ride” any of its transformations and learns from those corrections so indicated by the user.

7. e990 then utilizes the “transformed” data and the “on-hold” data to complete the e990 Schedule (in this example, the Financial Statements on 990 Parts VII-XI).

Also, Conditional Data is collected via an API, e990's Hyperautomation, integrally its robotic process automation (RPA), described in greater detail, collects the Conditional Data via two principal mechanisms:

(1) RPA Algorithms are programmed to produce these answers automatedly:
All cross references
All math results
Any field whose answer depends on the result of another field. Using the previously presented Conditional Data illustrative examples:

Did the organization report an amount in Part X line 21? If YES, complete Schedule D. e990 is coded to automatedly determine if there was an amount reported in X-21 and if the answer is YES, generates a report instructing the TEO to complete Schedule D
Did the organization report more than $15,000 of gross income from gaming activities on Part VIII, line 9a? If “Yes,” complete Schedule G, Part III

e990 is coded to automatedly determine if greater than $15,000 was reported in VIII-9a and if the answer is YES, generates a report instructing the TEO to complete

### Schedule G, Part III

Did the organization report an amount for investments—other securities in Part X, line 12, that is 5% or more of its total assets reported in Part X, line 16? If “Yes,” complete

### Schedule D, Part VII

e990 is coded to automatedly determine if X-12 is 5% or more of X-16 and if the answer is YES, generates a report instructing the TEO to complete Schedule G, Part III

AND

(2) RPA online interview with TEO where its “follow-up” response is required.

### EXAMPLES

After e990 determines the 3 largest Programs by expenses, per part III #4, e990 asks the TEO to provide the revenue, grants, and a description for each of those specific Programs.
After e990 identifies any Independent Contractors who were compensated>$100,000, per Part VII-B, e990 asks the TEO to provide its address and description of services.

FIG. 7 is a flowchart of an example automated Form 990 accounting method in accordance with some implementations.

Some implementations of e990 include “990 Accounting”, an essential function of the Data Tasks just described. The field of Accounting includes the branches of “Tax Accounting”, “Financial Accounting”, “Not-for-Profit Accounting” and “Project Accounting”. 990 Accounting can include a hybrid of the foregoing four branches; each of which parlay into preparing the Form 990. In some implementations, 990 Accounting can be powered by Hyperautomation, encompasses the analyses, calculations, alignments, and transformations required to generate the highly specific monetary schedules specified by the 990. 990 Accounting goes well beyond generic categorizations and assessments typically required in accounting and tax to generate data uniquely required by the Form 990.

In some implementations, e990 conducts 990 Accounting primarily for the e990 Schedules below:
(a) Program Services (990 Part III #4a-4e)
(b) Officers, Directors, Trustees, Key Employees and HCEs (990 Part VII-A)
(c) Independent Contractors (990 Part VII-B)
(d) Financial Statements (990 Parts VIII, IX, X and XI then to Part 1 #8-22)

Common TEO data sources and the data each contributes to the e990 Schedules are:
TEO DATA SOURCE PROVIDES TEO 990 DATA SET
Accounting system>>Chart of Accounts, trial balance, general/subsidiary ledgers
Payroll/HR system>>W2 and 1099 data, employee positions/titles
Donor/CRM system>>Donor data (names, dates and amounts of donations)
Ancillary sources>>>Any pertinent data as needed
(e.g. spreadsheets, emails, invoice)

In summary, e990's “990 Accounting” process encompasses:
(1) Extracting the TEO's 990 data sets from its heterogeneous sources
(2) e990, deploying its Hyperautomation, conducts its “990 Accounting” to transform the TEO's data into “e990 Schedule(s)”
(3) Routes the resulting e990 Schedules to e990's mapping/tax module to generate the 990
□ Appendix I depicts e990's deployment of “990 Accounting”
“990 Accounting” is necessitated by these unique accounting data requirements
which are unlike accounting in “for-profit” business tax returns:
A. Each REVENUE account must be classified by:

### (i) Payor Type:

Federated campaigns
Membership dues
Fundraising events
Related organizations
Government grants (contributions)
All other contributions, gifts, grants and similar amounts not included above
Noncash contributions included in above

Refer to 990 Part VIII, 1a through 1g

### (ii) Relatedness:

Related or exempt
Unrelated
Exempt per Sec 512-514

Refer to 990 Part VIII, columns (B), (C) and (D)

B. Each EXPENSE account must be classified by:

### (i) Payee Type:

Grants and other assistance to domestic organizations and governments
Grants and other assistance to domestic individuals
Grants and other assistance to foreign organization, governments and individuals
Benefits paid to or for members

Refer to 990 Part IX, 1 In, 4

### (ii) Function:

Program service
Management and general
Fundraising

Refer to 990 Part IX, columns (B), (C) and (D)

C. Each PROGRAM SERVICE Must be Separately Named then Classified as to its Respective:
Expenses
Grants
Revenue

### Refer to 990 Part III

D. Each PERSONNEL must be classified as to:
Name
Position
Function
Compensation

Refer to 990 Part VII-A, Part IX #5-7 and Part IX, Lines 5-7, columns B, C and D

See Appendix E for illustrative examples of 990 Accounting.

e990 Chart of Accounts

Largely due to the 990's unique accounting/reporting requirements as just described, a foundational component of e990's “990 Accounting” is the e990 Chart of Accounts.

A chart of accounts (CoA) is a structured list of all the accounts used by a TEO to record its financial transactions in the general ledger. Each TEO has its own unique CoA which reflects the organization's own accounting and reporting needs and preferred semantics. For example, one TEO's CoA may name the cost of its office space as “Rent”. Yet another TEO's CoA may name it as “Lease”. However, because the 990 uses pre-named (not “fill-in”) accounts for financial statement reporting on the 990, both of the afore-mentioned TEOs should list those costs under “Occupancy” (990 Expenses line 16). Thus, a very common challenge for TEOs is determining which 990 financial statement line-item best “matches” its CoA.

e990's CoA is a standard fixed CoA which directly aligns with the Form 990 and to which all TEOs financial statement trial balances are posted. (See Appendix B: “e990 Chart of Accounts”).

As a defining feature, e990's bespoke Hyperautomation transforms a TEOs financial statement data (typically its Chart of Accounts) to directly align with e990's CoA.
See Appendix C for such illustrative transformations.

FIG. 8 is a flowchart of an example data integration and mapping process in accordance with some implementations.

### Task 4: Data Integration and Mapping

As a defining feature, e990 auto-maps its e990 Data Processing results directly onto the correlating fields of the IRS Form 990. This step involves associating data fields with the corresponding fields on the prescribed form. For example, matching a TEO's name from the static data collected to the “Name of Organization” Page 1 Box C field on the form.

After e990 collects and processes the data, e990 then integrates and maps it by combining and structuring the data so that it specifically matches the format and structure of the prescribed 990 form. e990 accomplishes this integration and mapping using various tools and technologies, including:
a. Database Management Systems (DBMS): Where data is stored in a database, e990 uses SQL queries or ETL (Extract, Transform, Load) processes to extract, transform, and integrate the data into the needed 990 format.
b. ETL Tools: e990 also deploys ETL tools like Talend, Informatica, or Apache NiFi to automate the process of mapping data to specific formats.
c. Custom Code: e990 also utilizes custom code written in programming languages like Python, Java, or C# to perform data integration and mapping.

The attached Form 990 (Appendix E) depicts e990's mapping architecture by Data Domain.

Appendix I Provides an Overview of the e990 Data Ecosystem

### Hyperautomation

The core of e990's unique value offering of enabling TEOs to generate and file a Form 990 directly from the TEO data sources is, in part, due to the e990 Data ecosystem. e990's Hyperautomation, in turn, is key to how e990 administers that e990 Data.

e990's Hyperautomation, its highly tailored fusion of Artificial Intelligence, Automations, Intelligent Algorithms, Intelligent Data Capture and Data Techniques, is the most fundamental technology in e990's proprietary software system.

The e990 Data Ecosystem:
e990 Data: Definition and Index
e990 Data Domains
   e990 Data Tasks:
Task 1: Data Collection
Task 2: Data Preparation
Task 3: Data Processing

### (i) For all Static Data

(ii) For Dynamic Data: e990 Schedules
(iii) For Dynamic Data: All remaining
Task 4: Integration and Mapping
e990's Hyperautomation: The toolbox that powers e990's Data Tasks
   □ Feature 1>e990AI: e990's Artificial Intelligence
   □ Feature 2>e990RPA: e990's Robotic Process Automation
e990's Hyperautomation Toolbox
e990 is powered by HYPERAUTOMATION, its tailored fusion of Artificial
Intelligence, Automations, Intelligent Algorithms, Intelligent Data Capture and Data

Techniques working ensemble to transform raw TEO data to enable an optimally efficient and accurate preparation of the 990. See Appendix H.

A brief description of each component of e990's Hyperautomation toolbox:

Anomaly Detection: Identifies data points or patterns that deviate from the expected or typical results.

Artificial General Intelligence: A form of AI that possesses the ability to understand, learn, and apply knowledge in multiple domains, equivalent to human intelligence.

Association Rule Mining: Discovers interesting relationships or associations between variables in large datasets.

Automated A/B Testing: Uses automation to compare two versions of a data point to determine which one better meets a specified metric.

Automated Alerts and Triggers: System automatically sends notifications or activates processes based on specific data conditions or thresholds.

Bayesian Algorithms: Algorithms based on Bayes' theorem, used for predicting the probability of potential outcomes based on prior knowledge.

Big Data: Extremely large datasets that are challenging to process using traditional data management methods. It is characterized by its high volume, variety, and velocity, requiring specialized tools and techniques for storage, analysis, and visualization.

Chi-square Tests: Statistical tests that assess the relationship between categorical variables in a dataset.

Cluster Analysis: A technique that groups similar data points or objects based on characteristics or features.

Cognitive Computing: Systems that mimic human decision-making processes and can solve complex problems without human intervention.

Comparative Analysis: Examining the differences and similarities between two or more items.

Correlation Analysis: Determines the relationship/association between two or more variables.

Cross-tabulation: Method used to analyze relationship between two/more categorical variables.

Data Cleanup Automation: Automated processes that identify and rectify inconsistencies, errors, or duplicates in datasets.

Data Collection Automation: Tools or systems that automatically gather data from different sources.

Data Entry Automation: Systems that input data into databases or software with minimal human intervention.

Data Extraction: The process of retrieving or gathering data from various sources.

Data Integration Automation: Combining data from different sources to provide a unified view using automated processes.

Data Mining: Extracting useful patterns and insights from large data sets.

Data Reporting Automation: Tools that generate reports or summaries of data automatically at specified intervals.

Data Synchronization: Ensuring that datasets in different locations or platforms are consistent and updated.

Data Transformation and Preparation: Converting data into a desired format and getting it ready for analysis.

Data Validation: Ensuring the accuracy and quality of data against predefined criteria.

Data Visualization and Dashboards: Graphical representations of data and interfaces that display important metrics.

Decision Trees: Hierarchical models used for decision-making and classification in machine learning.

Deep Learning: A subset of machine learning using neural networks with multiple layers to analyze various factors of data.

Descriptive Statistics: Provides a summary and description of the main aspects of a dataset.

Dimensionality Reduction: Techniques that reduce the number of input variables in a dataset.

Document Classification and Categorization: Assigning predefined categories or labels to documents based on their content.

ETL Processes: Extract, Transform, Load processes used for data integration in databases.

Expert System: A computer system that mimics the decision-making ability of a human expert.

Exploratory Data Analysis: Initial investigations on data to discover patterns, anomalies, or relationships.

Fuzzy Logic Algorithms: Systems that consider uncertainties by assigning values between “true” and “false”, often used in decision-making.

Graph Algorithms: Algorithms designed to handle data structures like graphs or networks.

Inferential Statistics: Makes predictions or inferences about a population based on a sample.

Intelligent Character Recognition: Advanced optical character recognition that can recognize handwritten characters.

K-means Clustering: A method of vector quantization, often employed in cluster analysis.

Machine Learning: Algorithms that allow computers to perform tasks without explicit programming, by learning from data.

Natural Language Processing: A field of AI focused on the interaction between computers and human language.

Neural Networks: Set of algorithms modeled after the human brain, used in machine learning.

Optical Character Recognition: Technology that converts different types of documents into editable and searchable data.

Optical Mark Recognition: Technology used to detect the presence or absence of a mark, such as checkboxes on a tax return.

Pattern Recognition: Identifying patterns and regularities in data.

Predictive Analytics: Using data, algorithms, and machine learning techniques to identify the likelihood of future outcomes.

Random Forest: A machine learning method consisting of multiple decision trees, used for classification and regression.

Recommendation Systems: Algorithms that suggest items to users based on data analysis.

Regression Analysis: Evaluates the relationships between a dependent and one or more independent variables.

Reinforcement Learning Algorithms: Machine learning models that make sequences of decisions by rewarding desired behaviors and punishing undesired ones.

Robotic Process Automation: Using “bots” to emulate and integrate the actions of a human interacting within digital systems.

Spreadsheet Macros: Automated sequences in spreadsheets that repeat a set of commands or actions.

Support Vector Machine: Supervised machine learning algorithms used for classification or regression.

Template-based Capture: Automated data entry methods that use predefined templates to capture specific data from documents.

Text Analytics: The process of deriving meaningful information from unstructured text.

Trend Analysis: Analyzing data to identify patterns over time.

Virtual Assistant: Software entity designed to interact with users using natural language, aiding in tasks or answering questions.

Workflow Automation: Tools and technologies that automate routine and manual processes in a business environment.

990AI: e990's Artificial Intelligence

A vital component of e990's Hyperautomation is Artificial Intelligence technologies to with e990 pioneers 990AI, artificial intelligence that is distinctly and singularly trained to generate 990 Data.

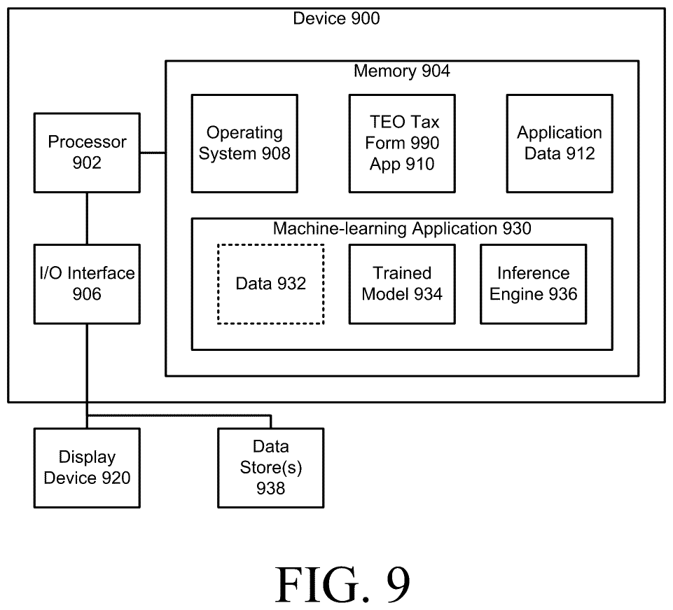

Due to the vast datasets and need to centralize data that's pulled from a sprawl of TEO data sources (see Appendix G), the 990AI model (e.g., 930 in FIG. 9) can incorporate one or more of the following AI development technologies, frameworks and tools, amongst others, that's best suited for each particular 990 Data Task:
Deep Learning Frameworks such as Tensor Flow, PyTirch, and Keras
Machine Learning Libraries such as Scikit-Learn and XGBoost
Natural Language Processing libraries such as NLTK, spaCy, and Hugging Face Transformers
AutoML tools such as Google AutoML and AutoKeras.
Data Processing and Analysis tools such as Pandas, NumPy, and Apache Spark
GPU Acceleration such as CUDA and cuDNN
Containerization and Orchestration such as Docker and Kubernetes
Version Control such as Git
Collaboration platforms such as GitHub, GitLab, Bitbucket
Cloud Services such as AWS, Azure, Google Cloud
Development Environments such as Jupyter Notebooks and Integrated Development Environments
(IDEs) like Visual Studio Code for code development.

### Model Deployment:

Docker and Kubernetes for containerized deployment.

AWS SageMaker, Azure ML, and Google AI Platform for cloud deployment

Flask and FastAPI for building API endpoints (see API section for more details)

### 990AI's Capabilities and Features:

encodes algorithms that are trained with large volumes of TEO data which serves as the foundation of the 990AI model.

learns from past transformations to 990 Data made by humans and uses this training to automatically transform new transactions.

detects anomalies in 990 Data based on learned patterns and flags them for “human-in-the-loop” review.

uses Machine Learning and Natural Language Processing, amongst other AI technologies, to learn from historical data and conversion results to continually improve its 990 model.

integrates a feedback loop where the system learns from the data patterns, making all of its 990 Data analytics more accurate over time.

uses software algorithms that adapt in real time to continually improve its 990 Data analytics; and

is able to adjust its 990 Data analytics based on assessments unique to each TEO such as its fiscal year end, Nonprofit sector, preferred semantics.

### 990AI Model:

The 990AI model is laser-focused on the intricacies of 990 Data to deliver pinpoint 990 Data accuracy.

990AI extracts select features from fundamental pre-trained AI models such as variants of BERT or GP-3, T5, XLNet and ERNIE (each accessed via API) and stacks those with e990's private, deeply customized “in house” AI model that's singularly trained on 990 Data to create a bespoke AI model ensemble (“990 AI model”).

As stated, 990AI extract capabilities from pre-trained models. This approach enables 990AI to augment its highly specialized “in house” AI model's performance and capabilities in these ways:

1. Feature Extraction: 990AI extracts embeddings or representations from different layers of a pretrained model and uses these representations as input features for downstream 990 tasks. For example, in NLP, 990AI extracts word embeddings or contextual embeddings from models like BERT or GPT-3 and uses them as features for 990 Data classification or clustering.

2. Fine-Tuning: Instead of using an entire pre-trained model, 990AI fine-tune specific layers or components of the model for a particular task. For instance,

3. Knowledge Transfer: 990AI transfer knowledge learned from one model to another. For example, 990 AI may be trained on a specific task using one foundational model and then transfer the knowledge (weights) learned to another pre-trained model or to 990AI's private AI model to improve performance on a related 990 Data task.

4. Ensemble Learning: 990AI combines the outputs of different foundational models using ensemble methods like majority voting, weighted averaging, or stacking. Because each model provides unique insights or predictions, the ensemble 990 Data outputs are accuracy enriched.

5. Feature Engineering: 990AI utilizes specific features or patterns learned by foundational models to design custom features or engineering strategies tailored to generating 990 Data. For example, 990AI extracts textual features from a language model and uses them as input features for a traditional machine learning algorithm.

6. Adaptive Combinations: 990AI dynamically adapts the combination of models or features based on the characteristics of the 990 Data or task at hand. For instance, you might choose different models or features for different input samples or subtasks within a larger problem.

### 990AI Model Development and Training:

The 990AI model is fine-tuned to conduct its 990 Accounting and otherwise generate 990 Data by e990 Data Task. e990's ensemble AI model allows it to leverage the strengths of different pre-trained models depending on the specific target e990 Data Task.

For each e990 Data Task, the 990AI model is developed by first validating its 990 Data outputs on smaller task-specific datasets containing labeled examples related to the specific e990 Data Task. The 990 AI model is fine-tuned by adjusting the model's parameters to make it more specialized for the target e990 Data Task.

The 990AI model is further fine-tuned by inputting additional 990 Task-specific training steps, such as adjusting hyperparameters or applying techniques like transfer learning to improve performance on the e990 Data Task.

Once the model proves its accuracy for the e990 Data Task, it's scaled up by incorporating reinforcement learning with human feedback (RLHF).

The 990AI model is continually fed with crafted text inputs, essentially teaching it to generate outputs that resonate with human intent.

The insights from human feedback are merged into the ongoing training so as to fine-tune the model so its results mirror human expectations seamlessly.

990AI integrates “Learning from Mistakes (LeMa)” which trains its AI model with human-like learning processes, such as learning from and correcting its own mistakes. 990AI's model trainers identifies any errors in its reasoning then and provides corrected reasoning paths to further train the original models; enhancing its reasoning capability.

Mistake-correction data pairs generated by models such as GPT-4 are used to fine-tune 990AI.

990AI constantly learns from new information and feedback about whether its prediction results were accurate, or if a more accurate option was available instead, to improve the prediction model going forward.

e990 provides accounting support/review (human-in-the-loop) where AI prediction results are below certain thresholds

### 990RPA: E990's Robotic Process Automation (Rpa)

Another key component of e990's Hyperautomation is Robotic Process Automation (RP A), a technology that e990 deploys principally to automate its rules-based tasks to achieve beginning-to-end automation of the 990.

e990 deploys leading RP A technologies, such as bots, to enable almost innumerable 990-tailored automations of e990's features and functions. These are illustrative instances of e990's RP As:

1. Macro-task automation examples:

e990 compares a TEO's roster which lists the names and positions of all personnel (employees, officers, directors, trustees, etc.) to its compensation records (e.g. W2s, 1099s) to automatedly determine which personnel meet the reporting criterion defined in 990 Part VIIA.

e990 reviews contribution records to determine if there are any loans between the TEO and a “substantial contributor” amongst others (as required by 990 X5 and X22)

e990 analyzes TEO's data sets to determine if there is any “other compensation” (i.e. not reported on W2) that needs to be reported in 990 Part VII column F

e990 assesses TEO's data sets to determine which of its program services are the 3 largest by expenses THEN calculate the revenue and grants which correlate to those identified programs (as required by 990 Part III #4)

e990 reviews data sets to determine which personnel meet defined positions and thus require segregated reporting (as required by 990 IX #5 and Part 7 key persons)

### 2. Singular-Task Automation Examples:

If an employee meets the reporting criteria of Part VII A, then e990 autoqueries “Please enter average hours per week” for its column (B)

If an independent contractor receives more than $100,000 compensation, then e990 auto-queries “enter description of services and business address” for VII=B 1 (A) and (B)

e990 extracts data from 1096 and W3 forms to populate Part V, 1 a and 2a respectively

3. Workflow automations: Must do “A” before “B” wherever required by 990

4. Cross-references are validated wherever required by 990 (e.g. Total revenue at Part 1 line 12 must equal Part VIII)

5. Conditional logic: “If_, then_” is executed wherever required by 990

6. Calculative conditional logic: If$_is greater than $_, then is executed wherever required by 990

7. e990's “990 Accounting”

8. e990's API for data retrieval, data entry, authentication credentials.

9. e990's tax software

10. e990's Virtual Assistant

11. e990's Data Tasks: collection, preparation, processing, integration and mapping

12. Workflow orchestration so that steps are executed in logical and/or required order

FIG. 9 is a block diagram of an example device 900 which may be used to implement one or more features described herein. In one example, device 900 may be used to implement a client device, e.g., any of client devices 120-126 shown in FIG. 1. Alternatively, device 900 can implement a server device, e.g., server device 104, etc. In some implementations, device 900 may be used to implement a client device, a server device, or a combination of the above. Device 900 can be any suitable computer system, server, or other electronic or hardware device as described above.

One or more methods described herein (e.g., methods of FIGS. 3-8) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 900 includes a processor 902, a memory 904, and I/O interface 906. Processor 902 can be one or more processors and/or processing circuits to execute program code and control basic operations of the device 900. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 902 may include one or more co-processors that implement neural-network processing. In some implementations, processor 902 may be a processor that processes data to produce probabilistic output, e.g., the output produced by processor 902 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 904 is typically provided in device 900 for access by the processor 902 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 902 and/or integrated therewith. Memory 904 can store software operating on the server device 900 by the processor 902, including an operating system 908, machine-learning application 930, TEO tax form application 910, and application data 912. Other applications may include applications such as a data display engine, web hosting engine, image display engine, notification engine, social networking engine, etc. In some implementations, the machine-learning application 930 and TEO tax form application 910 can each include instructions that enable processor 902 to perform functions described herein, e.g., some or all of the methods of FIGS. 3-8.

The machine-learning application 930 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a TEO tax form application 910 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 930 may utilize Bayesian classifiers, support vector machines, neural networks, or other learning techniques. In some implementations, machine-learning application 930 may include a trained model 934, an inference engine 936, and data 932. In some implementations, data 432 may include training data, e.g., data used to generate trained model 934. For example, training data may include any type of data suitable for training a model for TEO tax form tasks, such as raw financial data, transformed financial data, labels, thresholds, etc. associated with TEO tax form described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 934, training data may include such user data. In implementations where users permit use of their respective user data, data 932 may include permitted data.

In some implementations, data 932 may include collected data such as raw (or initial) financial data as described herein. In some implementations, training data may include synthetic data generated for the purpose of training, such as data that is not based on user input or activity in the context that is being trained, e.g., data generated from simulated conversations, computer-generated images, etc. In some implementations, machine-learning application 930 excludes data 932. For example, in these implementations, the trained model 934 may be generated, e.g., on a different device, and be provided as part of machine-learning application 930. In various implementations, the trained model 934 may be provided as a data file that includes a model structure or form, and associated weights. Inference engine 936 may read the data file for trained model 934 and implement a neural network with node connectivity, layers, and weights based on the model structure or form specified in trained model 934.

Machine-learning application 930 also includes a trained model 934. In some implementations, the trained model 934 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 932 or application data 914. Such data can include, for example, images, e.g., when the trained model is used for TEO tax form functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image is functional, etc. depending on the specific trained model. In some implementations, model form or structure also specifies a number and/or type of nodes in each layer.

In different implementations, the trained model 934 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 934 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 932, to produce a result.

For example, training may include applying supervised learning techniques. In supervised learning, the training data can include a plurality of inputs (e.g., a set of images) and a corresponding expected output for each input. Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 930. In various implementations, a trained model includes a set of weights, or embeddings, corresponding to the model structure. In implementations where data 932 is omitted, machine-learning application 930 may include trained model 934 that is based on prior training, e.g., by a developer of the machine-learning application 930, by a third-party, etc. In some implementations, trained model 934 may include a set of weights that are fixed, e.g., downloaded from a server that provides the weights.

Machine-learning application 930 also includes an inference engine 936. Inference engine 936 is configured to apply the trained model 934 to data, such as application data 914, to provide an inference. In some implementations, inference engine 936 may include software code to be executed by processor 902. In some implementations, inference engine 936 may specify circuit configuration (e.g., for a programmable processor, for a field programmable gate array (FPGA), etc.) enabling processor 902 to apply the trained model. In some implementations, inference engine 936 may include software instructions, hardware instructions, or a combination. In some implementations, inference engine 936 may offer an application programming interface (API) that can be used by operating system 908 and/or TEO tax form application 910 to invoke inference engine 936, e.g., to apply trained model 934 to application data 914 to generate an inference.

Machine-learning application 930 may provide several technical advantages. For example, when trained model 934 is generated based on unsupervised learning, trained model 934 can be applied by inference engine 936 to produce knowledge representations (e.g., numeric representations) from input data, e.g., application data 912. For example, a model trained for TEO tax form tasks may produce predictions and confidences for given input information about TEO tax forms. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 936.

In some implementations, knowledge representations generated by machine-learning application 930 may be provided to a different device that conducts further processing, e.g., over a network. In such implementations, providing the knowledge representations rather than the images may provide a technical benefit, e.g., enable faster data transmission with reduced cost. In another example, a model trained for functional image archiving may produce a functional image signal for one or more images being processed by the model.

In some implementations, machine-learning application 930 may be implemented in an offline manner. In these implementations, trained model 934 may be generated in the first stage and provided as part of machine-learning application 930. In some implementations, machine-learning application 930 may be implemented in an online manner. For example, in such implementations, an application that invokes machine-learning application 930 (e.g., operating system 908, one or more of TEO tax form application 910 or other applications) may utilize an inference produced by machine-learning application 930, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 934, e.g., to update embeddings for trained model 934.

In some implementations, machine-learning application 930 may be implemented in a manner that can adapt to particular configuration of device 900 on which the machine-learning application 930 is executed. For example, machine-learning application 430 may determine a computational graph that utilizes available computational resources, e.g., processor 902. For example, if machine-learning application 930 is implemented as a distributed application on multiple devices, machine-learning application 930 may determine computations to be carried out on individual devices in a manner that optimizes computation. In another example, machine-learning application 930 may determine that processor 902 includes a GPU with a particular number of GPU cores (e.g., 1000) and implement the inference engine accordingly (e.g., as 1000 individual processes or threads).

In some implementations, machine-learning application 930 may implement an ensemble of trained models. For example, trained model 934 may include a plurality of trained models that are each applicable to the same input data. In these implementations, machine-learning application 930 may choose a particular trained model, e.g., based on available computational resources, success rate with prior inferences, etc. In some implementations, machine-learning application 930 may execute inference engine 936 such that a plurality of trained models is applied. In these implementations, machine-learning application 930 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 908 or one or more other applications, e.g., TEO tax form application 910.

In different implementations, machine-learning application 930 can produce different types of outputs. For example, machine-learning application 930 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 930 may produce an output video with a particular effect applied, e.g., rendered in a comic-book or particular artist's style, when trained model 934 is trained using training data from the comic book or particular artist, etc. In some implementations, machine-learning application 930 may produce an output based on a format specified by an invoking application, e.g. operating system 908 or one or more applications, e.g., TEO tax form application 910. In some implementations, an invoking application may be another machine-learning application. For example, such configurations may be used in generative adversarial networks, where an invoking machine-learning application is trained using output from machine-learning application 930 and vice-versa.

Any of software in memory 904 can alternatively be stored on any other suitable storage location or computer-readable medium. In addition, memory 904 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 904 and any other type of storage (magnetic disk, optical disk, magnetic tape, or other tangible media) can be considered “storage” or “storage devices.”

I/O interface 906 can provide functions to enable interfacing the server device 900 with other systems and devices. Interfaced devices can be included as part of the device 900 or can be separate and communicate with the device 900. For example, network communication devices, storage devices (e.g., memory and/or database 106), and input/output devices can communicate via I/O interface 906. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 906 can include one or more display devices 920 and one or more data stores 938 (as discussed above). The display devices 920 that can be used to display content, e.g., a user interface of an output application as described herein. Display device 920 can be connected to device 900 via local connections (e.g., display bus) and/or via networked connections and can be any suitable display device. Display device 920 can include any suitable display device such as an LCD, LED, or plasma display screen, CRT, television, monitor, touchscreen, 3-D display screen, or other visual display device. For example, display device 920 can be a flat display screen provided on a mobile device, multiple display screens provided in a goggles or headset device, or a monitor screen for a computer device.

The I/O interface 906 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 9 shows one block for each of processor 902, memory 904, I/O interface 906, and software blocks 908, 912, and 930. These blocks may represent one or more processors or processing circuitries, operating systems, memories, I/O interfaces, applications, and/or software modules. In other implementations, device 900 may not have all of the components shown and/or may have other elements including other types of elements instead of, or in addition to, those shown herein. While some components are described as performing blocks and operations as described in some implementations herein, any suitable component or combination of components of environment 100, device 900, similar systems, or any suitable processor or processors associated with such a system, may perform the blocks and operations described.

In some implementations, logistic regression can be used for personalization. In some implementations, the prediction model can be handcrafted including hand selected labels and thresholds. The mapping (or calibration) from ICA space to a predicted precision within a space can be performed using a piecewise linear model.

In some implementations, the TEO tax form system could include a machine-learning model (as described herein) for tuning the system to potentially provide improved accuracy. Inputs to the machine learning model can include ICA labels, an image descriptor vector that describes appearance and includes semantic information about financial data. Example machine-learning model input can include labels for a simple implementation and can be augmented with descriptor vector features for a more advanced implementation. Output of the machine-learning module can include a transformation of raw financial data into TEO tax form data.

One or more methods described herein (e.g., methods of FIGS. 3-8) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
collecting, using one or more processors, data associated with a tax-exempt organization to produce collected data;
preparing, using the one or more processors, the collected data to produce prepared data;
processing, using the one or more processors, the prepared data to produce processed data;
programmatically performing an accounting process, using the one or more processors, on the processed data;
integrating and mapping, using the one or more processors, result data of the programmatic accounting process, wherein the integrating and mapping include placing data into appropriate locations within an electronic IRS Form 990; and
electronically filing, using the one or more processors, the electronic IRS Form 990.

2. The method of claim 1, further comprising providing a virtual assistant configured to provide recommendations and notifications.

3. The method of claim 1, wherein the collecting includes collecting static and dynamic data of the TEO.

4. The method of claim 1, wherein preparing the data includes cleansing the data and validating the data.

5. The method of claim 1, wherein processing the data includes processing static data and dynamic data.

6. The method of claim 1, wherein the accounting includes:
extracting Form 990 data from processed data via hyperautomation;
programmatically transforming extracted TEO data into electronic IRS Form 990 schedules via hyperautomation; and
classifying each revenue item, expense item, program service item and personnel member.

7. The method of claim 1, wherein the data integration and mapping include combining and structuring data.
